(19) United States
(12) Patent Application Publication
(10) Pub. No.: US 2010/0128560 A1
(43) Pub. Date: May 27, 2010

(54) MIXER AND METHOD FOR MIXING A LIQUID IN A BASIN

(75) Inventors: Ulf Carlsson, Sollentuna (SE); Jan Lundkvist, Svartsjo (SE)

Correspondence Address: BROWDY AND NEIMARK, P.L.L.C.;624 NINTH STREET, NW, SUITE 300, WASHINGTON, DC, 20001-5303, US

(73) Assignee: ITT MANUFACTURING ENTERPRISES INC,, WILMINGTON, DE (US)

(21) Appl. No.: 12/279,764

(22) PCT Filed: Mar. 13, 2007
(86) PCT No.: PCT/SE07/50143

§ 371 Date: Aug. 18, 2008

(30) Foreign Application Priority Data
Mar. 16, 2006 (SE) 0600582-1

(51) Int. Cl. B01F 7/06

(52) U.S. Cl. 366/286

(57) ABSTRACT

The invention relates to a mixer for mixing a liquid in a basin, comprising a first mixer element turnable around a first axis of rotation. Furthermore, said mixer (1) comprises a second mixer element (3) turnable around a second axis of rotation, the first mixer element (2) and the second mixer element (3) being connected to each other by means of a connector (4), which is arranged to provide joint turning of the first mixer element (2) and the second mixer element (3), and that the output of at least one of said first mixer element (2) and said second mixer element (3) is adjustable. The invention also relates to a method for mixing a liquid in a basin.

### TECHNICAL FIELD OF THE INVENTION

The present invention relates generally to the field of mixers, and more specifically to a mixer for mixing a liquid in a basin, such as sewage or waste water. Such a mixer comprises a first mixer element, which is turnable around a first axis of rotation. The present invention also relates to a method for mixing a liquid in a basin.

### BACKGROUND OF THE INVENTION

In basins, tanks, etc. located within a sewage station, for treating sewage or waste water, it is often the case that the liquid has to be in motion in order to keep solid matter suspended in the liquid. Without a continuous motion the solid matter will settle on the bottom of the basin, which may adversely affect subsequent process steps.

In order to solve the problem that solid matter settles, it is known to lower a mixer into the liquid, which circulates/agitates the liquid and thus keeps the solid matter suspended. A simple type of mixer is a stationary mixer that is connected to a shaft or the wall of the basin. A disadvantage concerning a stationary mixer is that only a part of the liquid volume in the basin may be circulated, more precisely only the liquid just in front of the mixer. The liquid in large parts of the basin is unaffected, and the solid matter in these parts may settle. In order to get all solid matter suspended the stationary mixer has to be oversized, which involves heavy expenditures. By using several stationary mixers located all around the basin, each covering a small part of the basin, a better circulation/motion is achieved. However, each mixer stand for a considerable cost and in order to lower the total costs and at the same time cover a large volume of the basin, a movable mixer may be used. Such a mixer is usually moved/turned by means of an external engine, which reciprocating turns the shaft supporting the mixer. The movability of the mixer result in that by means of only one mixer a larger volume of the basin may be covered, and thereto the liquid flow/motion may be controlled in a more adapted way according to the existing circumstances and the application. However, one disadvantage concerning this type of movable mixers is that the auxiliary equipment, that is needed to execute the reciprocating motion of the mixer, is expensive and of considerable size in relation to the mixer.

In EP 0,286,611 B, a mixer is shown which need no external engine in order to turn the mixer. Instead the mixer uses a mechanical solution comprising articulated blades, which works like a rudder and forces the mixer to turn around an axis of rotation. At the two end positions of the oscillation, the orientation of the blades is mechanically shifted in order to force the mixer in the opposite direction. A disadvantage associated with this type of movable mixers is that solid matter may get tangled among the blades and joints, and thereby preventing proper operation of the mixer. Further, such a movable mixer may only oscillate between two end positions, without having the possibility to be controlled or temporarily stopped at different intermediate positions.

### SUMMARY OF THE INVENTION

The present invention aims at obviating the aforementioned disadvantages of previously known mixers, and at providing an improved mixer. An object of the present invention is to provide a mixer of the initially defined type, the turning of which is executed by the mixer itself. It is another object of the present invention to provide a mixer, which may be turned to different positions and/or at different speed without the need for expensive auxiliary equipment.

According to the invention at least the primary object is attained by means of the initially defined mixer having the features defined in the independent claim. Preferred embodiments of the present invention are further defined in the dependent claims.

According to the present invention, there is provided a mixer, which comprises a second mixer element turnable around a second axis of rotation, the first mixer element and the second mixer element being connected to each other by means of a connector, which is arranged to provide joint turning of the first mixer element and the second mixer element, and that the output of at least one of said first mixer element and said second mixer element is adjustable.

Thus, the present invention is based on the insight that a movability/turnability of the mixer is achievable by means of two counteracting and interconnected mixer elements, which are jointly turnable in relation to the basin. More precisely, the individual mixer element should, if not connected to the other mixer element, rotate around the corresponding axis of rotation during operation. The first mixer element should rotate clockwise and a second mixer element should rotate counterclockwise, but since they are interconnected they will counteract each others uncontrolled rotation.

In a preferred embodiment of the present invention, the first axis of rotation and the second axis of rotation coincide with each other.

According to another embodiment of the present invention, the output of both the first mixer element and the second mixer element is adjustable.

According to a second aspect of the present invention, there is provided a method according to claim 10.

### BRIEF DESCRIPTION OF THE DRAWINGS

A more complete understanding of the above mentioned and other features and advantages of the present invention will be apparent from the following detailed description of preferred embodiments in conjunction with the appended drawings, wherein:

FIG. 1 is an elevational view from above of a preferred embodiment of the mixer according to the invention,

FIG. 2 is a side view of the mixer according to FIG. 1,

FIG. 3 is an elevational view from above of a second embodiment of the mixer according to the invention,

FIG. 4 is an elevational view from above of a third embodiment of the mixer according to the invention,

FIG. 5 is an elevational view from above of a forth embodiment of the mixer according to the invention,

FIG. 6 is an elevational view from above of a fifth embodiment of the mixer according to the invention, and

FIG. 7 is a side view of a sixth embodiment of the mixer according to the invention.

### DETAILED DESCRIPTION OF PREFERRED EMBODIMENTS OF THE INVENTION

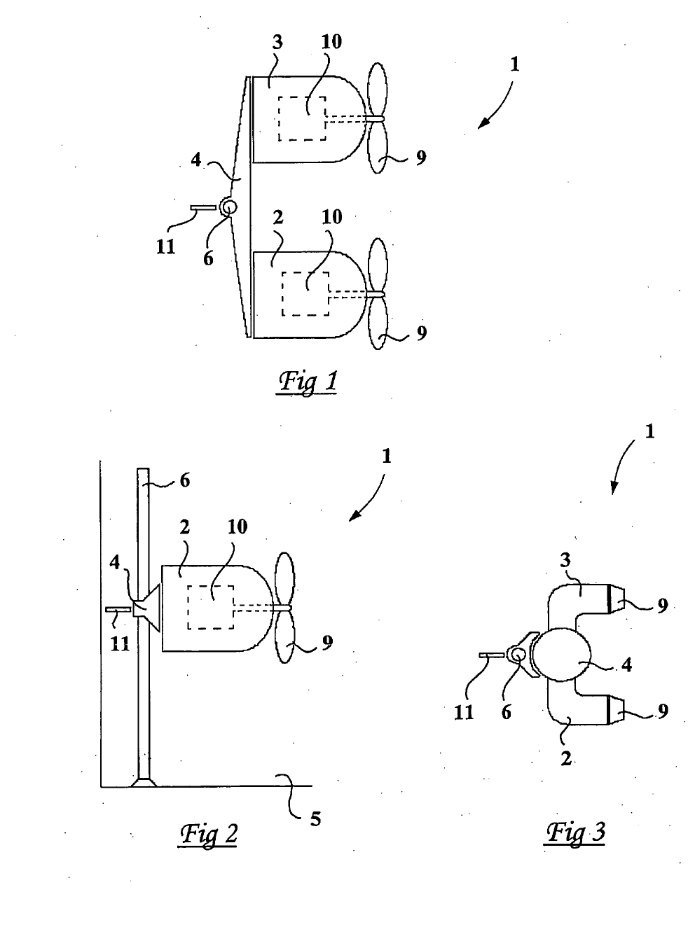

FIGS. 1 and 2 show a preferred embodiment of a mixer 1 according to the invention. The mixer 1 comprises at least two mixer elements, a first mixer element 2 and a second mixer element 3, which are connected to each other by means of a connector 4. In FIG. 2 only the first mixer element 2 is shown, because the second mixer element 3 is at the same level and thereby hidden behind the first mixer element 2. However, it shall be pointed out that the first mixer element 2 and the second mixer element 3 may be at different levels. The mixer 1 is in its entirety lowered into a basin 5, a tank or the like (see FIG. 2), containing a liquid/sewage water that needs to be agitated/circulated, e.g. in order to keep solid matter comprised in the liquid suspended. Otherwise the solid matter may settle and accumulate on the bottom of the basin 5.

The first mixer element 2 is turnable around a first axis of rotation, which in the shown embodiment of FIGS. 1 and 2 coincide with a shaft or post 6. Said shaft 6 is in a preferred embodiment fixed to the bottom and/or the wall of the basin 5, whereupon the connector 4 of the mixer 1 is turnable around said shaft 6. However, it shall be pointed out that the shaft 6 may be turnable in relation to the basin 5, whereupon the connector 4 is fixedly connected to said shaft 6. The second mixer element 3 is turnable around a second axis of rotation, which in the shown embodiment coincide with said first axis of rotation and said shaft 6. The connector 4 is arranged to provide joint turning of the first mixer element 2 and the second mixer element 3.

Each of the first mixer element 2 and the second mixer element 3 comprises means 9 for affecting the liquid, i.e. causing a flow or agitation in the liquid contained in the basin 5. The agitation means 9 may for instance be a propeller as in the shown embodiment of FIGS. 1 and 2.

Reference is now made to FIG. 3, in which a second embodiment of the invention is shown. The agitation means of this embodiment is constituted by a hydroejector, jet propulsion unit, or the like, using an appropriate fluid such as a liquid, a gas or a mixture thereof. The first mixer element 2 and the second mixer element 3 are connected to each other by means of a connector 4, which in this embodiment also form a feeding duct and/or a distributor valve to the hydroejectors 9.

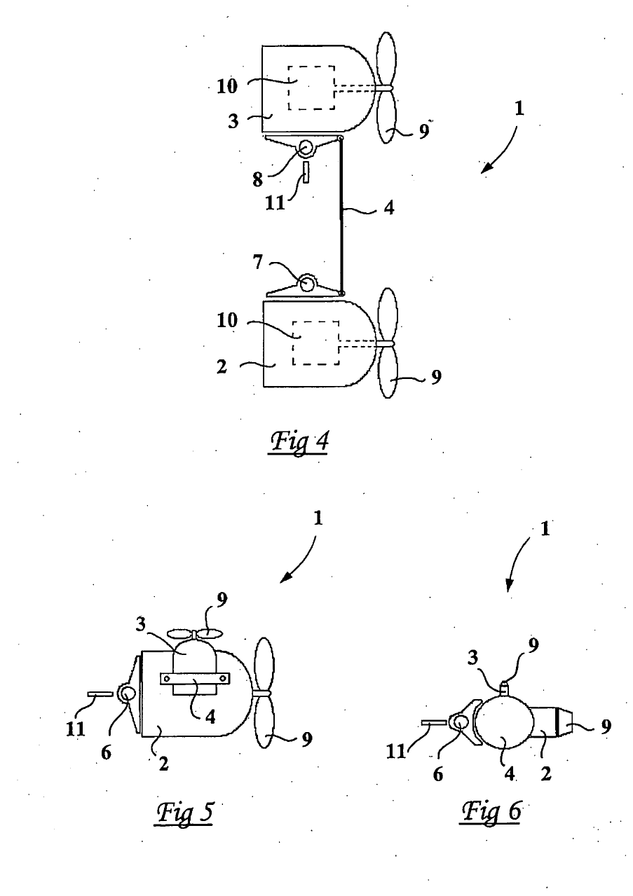

Reference is now made to FIG. 4, in which a third embodiment of the present invention is shown. The mixer 1 comprises a first mixer element 2 turnable around a first axis of rotation, which coincide with a first shaft 7, and a second mixer element 3 turnable around a second axis of rotation, which coincide with a second shaft 8. The first shaft 7 and the second shaft 8 are spaced apart from each other. Further, the first mixer element 2 and the second mixer element 3 are connected to each other by means of a connector 4. Said connector 4 may be a rigid rod that is articulately journalled in relation to the first mixer element 2 and the second mixer element 3, and that is spaced apart from and extends essentially parallel to an imaginary line extending between the first shaft 7 and the second shaft 8. Due to this arrangement, the first mixer element 2 and the second mixer element 3 may be located spaced apart from each other, and consequently cover a larger part of the basin 5. The connector 4 is arranged to provide joint turning of the first mixer element 2 and the second mixer element 3. It should also be pointed out that the rigid rod 4 may be replaced by two wires or pull rods, one on each side of said imaginary line extending between the first shaft 7 and the second shaft 8. The two wires should in a preferred embodiment be essentially parallel to each other and to the imaginary line. If the distance between the first mixer element 2 and the second mixer element 3 is big, a rigid rod 4 may be exposed to buckling, but two interacting wires obviates this problem.

Reference is now made to FIGS. 1-4. The output of each of the first and second mixer elements 2, 3 is controlled individually. In one embodiment the output of the first mixer element 2 may be fixed at a predetermined level, at the same time as the output of the second mixer element 3 is adjustable within a preset range. Said range includes output values lower than, equal to and higher than, the output level of the first mixer element 2. The same reasoning is applicable to the inverted condition, i.e. the output of the second mixer element 3 is fixed and the output of the first mixer element 2 is adjustable. In a preferred embodiment, the output of the first mixer element 2 as well as the output of the second mixer element 3 is adjustable. The output is preferably adjustable within the range from 0% to 100% of the available output. In a preferred embodiment of the invention each of the first mixer element 2 and the second mixer element 3 comprises a power source 10, e.g. an electrical motor connected to the propeller 9, the frequency or output of the electrical motors 10 being individually adjustable. Alternatively a common power source may be used, whereupon the output to each individual mixer element may be adjusted by means of a suitable transmission. In the case of hydroejectors a common pump may be used, whereupon adjustable valves determine the output to each mixer element, alternatively each hydroejector is connected to a separate pump, or the like. It should also be pointed out that for some agitation means 9, such as propellers, a drift or wandering of the mixer element may occur. This movement has to be compensated for in order to counteract unintended turning of the mixer 1.

A centre line of the first mixer element 2 and a centre line of the second mixer element 3 are at a distance from the respective axis of rotation. It shall be pointed out that by “centre line” means a line of the mixer element that coincides with the centre line of the affect of the agitation means 9 on the liquid contained in the basin. Preferably, said centre lines of the first mixer element 2 and the second mixer element 3 are parallel with each other and with a horizontal plane. However, it shall be pointed out that said centre lines may intersect with each other, either upstreams of the agitation means 9 or downstreams of the agitation means 9, seen in the liquid flow direction caused by the agitation means 9 during operation of the mixer 1. Further, said centre lines may be inclined in vertical direction in relation to each other and/or in relation to a horizontal plane.

One feature of the invention as shown in FIGS. 1-4, is that the first mixer element 2 is arrange in such a way that it during operation strive to turn in a first direction, e.g. clockwise, around the first axis of rotation, at the same time as the second mixer element 3 is arrange in such a way that it during operation strive to turn in the opposite direction, e.g. counterclockwise, around the second axis of rotation. If the first mixer element 2 and the second mixer element 3 have the same momentary output; their respective strive to turn in opposite directions will mutually counteract the turning of the opposite mixer element since they are interconnected by the connector 4, and consequently the mixer 1 will be located in one fixed position. A difference in output will make the mixer 1 turn in either direction.

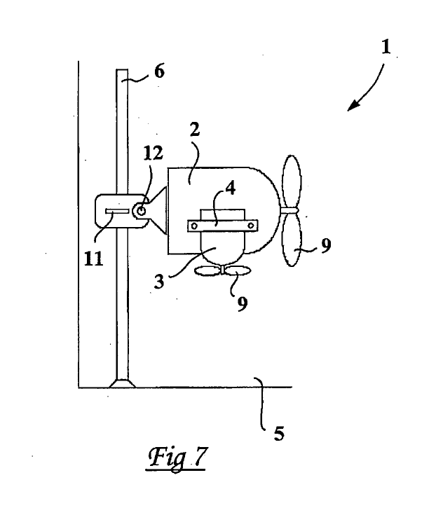

Reference is now made to FIGS. 5-7, in which additional embodiments of the present invention are shown. In these embodiments, the centre line of the first mixer element 2 more or less intersects the first axis of rotation. Furthermore, the centre line of the second mixer element 3 is arranged at an angle in relation to the centre line of the first mixer element 2, preferably at a right angle. In addition, the second mixer elements 3 are smaller than the corresponding first mixer elements 2, and the main purpose of which is primarily to generate turning of the mixer 1, although the second mixer elements 3 at the same time agitate the liquid. In the embodiment of FIG. 5 the agitation means or propeller 9 of the second mixer element 3 may be reversible, in order to get the mixer 1 to turn in both directions. In the embodiment of FIGS. 5-6 the agitation means 9, propeller or hydroejector, of the second mixer element 3 may operate against the influence of an elastic element (not shown). For instance, a coil spring may be arranged inside the shaft 6, connected to the bottom of the basin 5 and the shaft 6, the shaft 6 being fixed to the mixer 1 and turnable in relation to the basin 5. The inherent spring force of the elastic element and the output of the second mixer element 3 may be counterbalanced to each other, in order to get a desired control of the turning of the mixer 1. From the balanced position, the output of the second mixer element 3 may be increased or decreased in order to turn the mixer 1. Alternatively, the output of the second mixer element 3 may be intermittently operated, during each operating period of the second mixer element 3 the mixer 1 turns and during each break the mixer 1 is brought back to the initial position by the elastic element. The start and stop of the second mixer element 3 may in these embodiments be controlled by means of a timer (not shown). In the embodiment of FIG. 7, the first mixer element 2 and the second mixer element 3 are turnable around a common horizontal axis of rotation 12, and in this embodiment the second mixer element 3 operate against the gravitational effect on the mixer 1. The output of the second mixer element 3 is counterbalanced to said gravitational effect on the mixer 1. Alternatively, the mixer 1 may be connected to a counterweight (not shown), and thereby the second mixer element 3 is only operated in order to adjusts the angle of operation of the mixer 1 in relation to a horizontal plane.

Reference is now made to FIGS. 1-7. In a preferred embodiment, the mixer 1 comprises a control unit (not shown) operatively connected to the mixer 1, in order to adjust the output of the first mixer element 2 and/or the second mixer element 3, more precisely the output of the power source 10 of the first mixer element 2 and/or the second mixer element 3. Further, the mixer 1 comprises a position sensor 11, which is operatively connected to said control unit and which transmits continuous or discrete signals to the control unit regarding the momentary position of the mixer 1 in relation to the basin 5, or in relation to the first and second axes of rotation. In the simplest embodiment, the position sensor 11 is constituted by two limit switches, or timers, which stops the turning of the mixer 1 at each end position and thereafter the mixer 1 is returned in the opposite direction, in order to obtain reciprocating motion of the mixer 1. By means of a more sophisticated position sensor 11 and the control unit, the momentary position of the mixer 1 may be determined. Consequently, the movement of the mixer 1 may be controlled more adapted to the present application/circumstances. The mixer 1 may turn/oscillate at different speed and/or different angles and/or between different discrete positions in order to make shorter or longer stops, depending on the application, in order to have full control of the function and direction of the mixer 1. More precisely, the motion pattern of the mixer 1 may be whichever desirable.

Reference is now made to FIGS. 1-4. Thus, the turning of the mixer 1 is executed by applying a higher output from the power source 10 of the first mixer element 2 to the agitating means 9 of the first mixer element 2, than the output from the power source 10 of the second mixer element 3 to the agitating means 9 of the second mixer element 3, or vice versa. If the output of the first mixer element 2 is equal to the output from the second mixer element 3, then the mixer 1 operates located in a fixed position. Depending on the difference in output of the mixer elements, the mixer 1 will turn at a faster or slower speed in either direction.

### Feasible Modification of the Present Invention

The invention is not limited only to the embodiments described above and shown in the drawings. Thus, the mixer may be modified in all kinds of ways within the scope of the appended claims.

It shall be pointed out that intermediate mixer element(s) may be located between the first mixer element and the second mixer element, in order to increase the total output of the mixer. Preferably, the output of such an intermediate mixer element could be fixed at a predetermined level.

It shall also be pointed out that the first mixer element and the second mixer element not necessarily have to be located in the same vertical plane, and the mixer may comprise a plurality of first mixer elements located on different levels and/or a plurality of second mixer elements located on different levels, in order to increase the total output of the mixer.

The term “output”, as used in the claims as well as in the description, is defined as the resulting affect from the agitation means on the liquid. This may, for instance, be done by adjusting the frequency of the electric motor of the first and/or second mixer element.

Finally, it should be pointed out that different features from the different embodiments may be combined, even though it is not indicated in the description.

1. A mixer for mixing a liquid in a basin, comprising a first mixer element (2) turnable around a first axis of rotation, characterized in that said mixer (1) comprises a second mixer element (3) turnable around a second axis of rotation, the first mixer element (2) and the second mixer element (3) being connected to each other by means of a connector (4, 4′), which, in use, is arranged to provide joint turning of the first mixer element (2) and the second mixer element (3), and that the output of at least one of said first mixer element (2) and said second mixer element (3) is adjustable.

2. A mixer according to claim 1, wherein said first axis of rotation and said second axis of rotation coincide with each other.

3. A mixer according to claim 1 or 2, wherein the first mixer element (2) and the second mixer element (3) are provided with agitation means (9).

4. A mixer according to claim 3, wherein said agitation means (9) are propellers.

5. A mixer according to claim 3, wherein said agitation means (9) are jet propulsion units.

6. A mixer according to any of claims 1-5, wherein the output of the first mixer element (2) and the second mixer element (3) are individually adjustable.

7. A mixer according to any of claims 1-6, wherein the mixer (1) comprises a control unit for the adjustment of the output of at least one of the first mixer element (2) and the second mixer element (3).

8. A mixer according to any preceding claim, wherein a centre line of the first mixer element (2) is essentially in parallel with a centre line of the second mixer element (3).

9. A mixer according to claim 7, wherein the centre line of the first mixer element (2) and the centre line of the second mixer element (3), are essentially in parallel with a horizontal plane.

10. A method for mixing a liquid in a basin, comprising the steps of:
providing a mixer (1) in the liquid, said mixer (1) comprising a first mixer element (2) turnable around a first axis of rotation and a second mixer element (3) turnable around a second axis of rotation, said mixer elements being connected to each other by means of a connector (4, 4′), which provides joint turning of said mixer elements, and
adjusting the output of at least one of the first mixer element (2) and the second mixer element (3), in order to turn said mixer (1).
